(19) United States
(12) Patent Application Publication
(10) Pub. No.: US 2008/0318115 A1
(43) Pub. Date: Dec. 25, 2008

(54) FLOW CHANNEL PLATE

(75) Inventors: Cheng Wang, Hsinchu (TW); Nien-Hui Hsu, Hsinchu (TW); Ching-Po Lee, Hsinchu (TW); Jin-Shu Huang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/962,113

(22) Filed: Dec. 21, 2007

(30) Foreign Application Priority Data
Jun. 20, 2007 (TW) 96122023

(51) Int. Cl. H01M 2/18

(52) U.S. Cl. 429/39

(57) ABSTRACT

A flow channel plate suitable for use in a fuel cell including a plate body and at least a group of flow guiding blocks is provided. The plate body has a first side wall and a second side wall opposite to the first side wall. The first side wall has at least an inlet and the second side wall has at least an outlet. The group of flow guiding blocks is disposed in the plate body and is adjacent to the first side wall, and includes a plurality of flow guiding blocks. One of the flow guiding blocks is a first flow guiding block aligned with the inlet. The rest of flow guiding blocks are arranged into m rows between the first flow guiding block and the second side wall and the first row thereof is adjacent to the first flow guiding block. Where m is a nature number.

### CROSS-REFERENCE TO RELATED APPLICATION

This application claims the priority benefit of Taiwan application serial no. 96122023, filed on Jun. 20, 2007. The entirety of the above-mentioned patent application is hereby incorporated by reference herein and made a part of this specification.

### BACKGROUND OF THE INVENTION

1. Field of the Invention

The present invention relates to a flow channel plate, and more particularly, to a flow channel plate suitable for use in a fuel cell.

2. Description of Related Art

Fuel cell has the advantages of high efficiency, low noise and pollution-free, and is a fuel technology conforming to the trend of the present times. Fuel cells are classified into many types, while the commonly seen fuel cells are PEMFC (proton exchange membrane fuel cell) and DMFC (direct methanol fuel cell).

DMFC uses methanol-water solution as a fuel supply source, and generates current through related electrode reactions of methanol, oxygen and water. The chemical reactions are indicated as follows.

Anode: CH₃OH+H₂O→CO₂+6H⁺+6e⁻

Cathode: 3/2O₂+6H⁺6e⁻→3H₂O

Overall reaction: CH₃OH+H₂O+3/2O₂→CO₂+3H₂O

A DMFCDMFC usually has an anode flow channel plate for supplying methanol-water solution. The methanol-water solution entered into the anode flow channel plate reacts with anode catalyst.

Referring to FIG. 1, a conventional anode flow channel plate 100a has a serpentine flow channel 110 which has an inlet 112 and an outlet 114. The methanol-water solution passes through the serpentine flow channel 110 from the inlet 112 by using a pump. The methanol-water solution flows along the serpentine flow channel 110 and flows out of the serpentine flow channel 110 from the outlet 114.

Since the length of the serpentine flow channel 110 is relatively long, and which leads to a too large pressure drop while the methanol-water solution flows. Therefore, a pump that can produce a higher pressure is needed in order to drive the methanol solution, so it is more energy consuming. In addition, the methanol-water solution of the upstream of the serpentine flow channel 110 flows to the downstream of the serpentine flow channel 110 after reaction. As a consequence, the concentration of the methanol-water solution of the downstream is lower than the concentration of the methanol-water solution of the upstream. In other words, the concentration of the methanol-water solution in the anode flow channel plate 100a is uneven, and this leads to poor reaction efficiency.

Referring to FIG. 2, a conventional anode flow channel plate 100b has a parallel-connected flow channel 120, and the parallel-connected flow channel 120 has an inlet 122, an outlet 124 and a plurality of flow channels 126. Since there is a plurality of flow channels 126 in the parallel-connected flow channels 120, the above problem of uneven concentration of the methanol-water solution can be softened. However, as the flux of each flow parallel 126 in the parallel-connected flow channel 120 is hard to be averagely distributed, when carbon dioxide is accumulated in one of the certain flow channels 126, an increased flow resistance in the flow channel 126 may be resulted. This results in methanol-water solution likely flowing to other flow channels 126 with lower flow resistance; therefore the carbon dioxide in the flow channel 126 is hard to discharge.

### SUMMARY OF THE INVENTION

The present invention provides a flow channel plate to increase the reaction efficiency of fuel cell.

An embodiment of the present invention provides a flow channel plate suitable for use in a fuel cell. The flow channel plate includes a plate body and at least a group of flow guiding blocks. The plate body has a first side wall and a second side wall opposite to the first side wall. The first side wall has at least an inlet; and the second side wall has at least an outlet. The group of flow guiding blocks is disposed in the plate body and is adjacent to the first side wall, and includes a plurality of flow guiding blocks. One of the flow guiding blocks is a first flow guiding block, and the first flow guiding block is aligned with the inlet. The rest of the flow guiding blocks are arranged into m rows between the first flow guiding block and the second side wall and the first row of the m rows is adjacent to the first flow guiding block, and a number Nₘ of flow guiding blocks of the m^{th} row is plural, where m is a natural number, and Nₘ₊₁≧Nₘ. A geometrical center of the flow guiding blocks at one end of the first row and a geometrical center of the first flow guiding block are on a straight line, and an included angle is formed between the straight line and the first side wall.

The flow channel plate guides the flow of fluid in the flow channel plate through the flow guiding block. When the flow channel plate is used as the anode flow channel plate of fuel cell, the flow guiding blocks can make an even distribution of fuel introduced into the flow channel plate. Thus, fuel can evenly flow to the anode catalyst, so the reaction efficiency is increased.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a conventional anode flow channel plate with a serpentine flow channel.

FIG. 2 is a schematic diagram of a conventional anode flow channel plate with parallel-connected flow channels.

FIG. 3 is a schematic diagram of a flow channel plate according to an embodiment of the present invention.

FIG. 4 is a schematic diagram of a flow channel plate according to another embodiment of the present invention.

FIG. 5 is a schematic diagram of a flow channel plate according to another embodiment of the present invention.

FIG. 6 is a schematic diagram of a flow channel plate according to another embodiment of the present invention.

FIG. 7 is a schematic diagram of a flow channel plate according to another embodiment of the present invention.

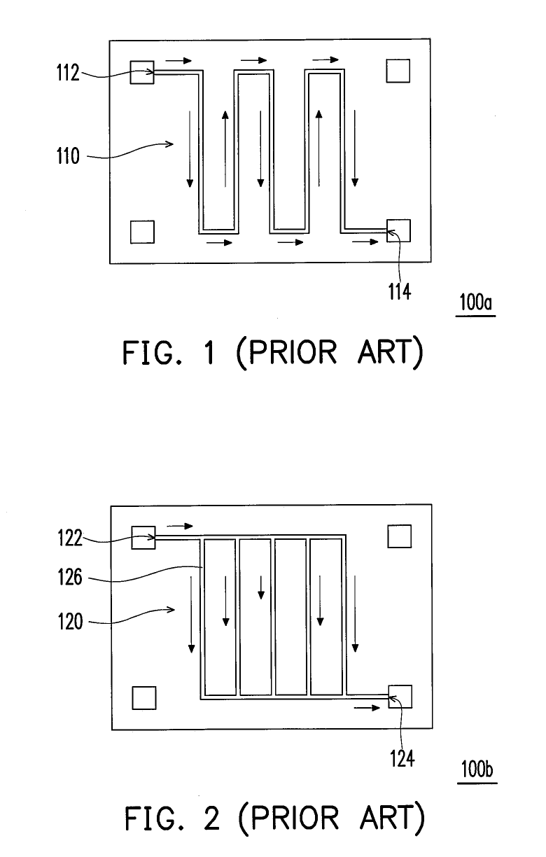

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,”. “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

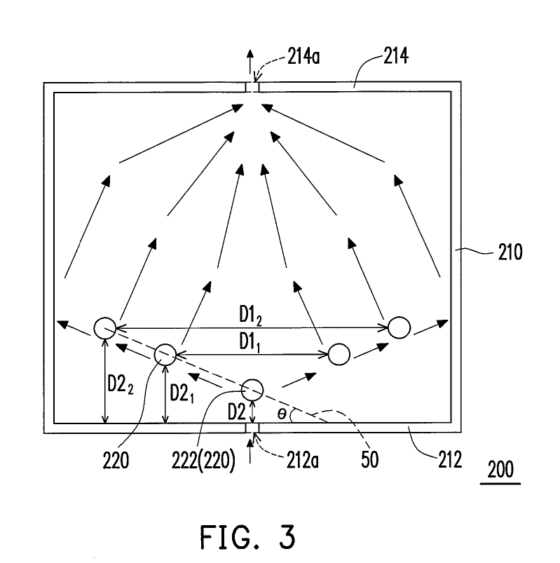

Referring to FIG. 3, the flow channel plate 200, according an embodiment of the present invention, is suitable for use in a fuel cell as the anode flow channel plate of a fuel cell. The flow channel plate 200 includes a plate body 210 and at least one group of guide blocks 220. The plate body 210 has a first side wall 212 and a second side wall 214 opposite to the first side wall 212. The first side wall 212 has an inlet 212a, the second side wall 214 has an outlet 214a. The flow guiding blocks 220 are disposed in the plate body 210, and are adjacent to the first side wall 212. In addition, the first side wall 212, for example, is parallel to the second side wall 214. The inlet 212a, for example, is in the center of the first side wall 212.

According to the above description, the inlet 212a, for example, is aligned with the outlet 214a, and one of the flow guiding blocks 220 is a first flow guiding block 222, and the first flow guiding block 222 is aligned with the inlet 212a. In other words, the first flow guiding block 222, the inlet 212a and the outlet 214a, for example, are in the same straight line. The dimension of the first flow guiding block 222, for example, is larger than the dimension of the inlet 212a. In addition, the rest of the flow guiding blocks 220 are arranged into m rows between the first flow guiding blocks 222 and the second side wall 214, and the first row of the m rows is adjacent to the first flow guiding block 222. In addition, the number Nₘ of the flow guiding blocks 220 of m^{th} row is plural, wherein m is a natural number, and Nₘ₊₁≧Nₘ.

In the present embodiment, for example, the number of the flow guiding blocks 220 is five, and the flow guiding blocks 220 other than the first flow guiding block 222 are arranged into two rows, and the number of the flow guiding blocks 220 in each row is two. In addition, a straight line 50 passes through the geometrical center of the flow guiding blocks 220 of one end of the first row and the geometrical center of the first flow guiding block 222, and there is an included angle θ between the straight line 50 and the first side wall 212.

The distance between the flow guiding blocks 220 at the two ends of the m^{th} row is D1ₘ and D1ₘ₊₁≧D1ₘ. More specifically, the distance D1₂ between the flow guiding blocks 220 at the two ends of the second row is longer than the distance D1₁ between the flow guiding blocks 220 at the two ends of the first row. In addition, the flow guiding blocks 220 at the two ends of the m^{th} row are at the two sides of the inlet 212a. In addition, the shortest distance between the first flow guiding block 220 and the first side wall 212 is D2, and the shortest distance between each of the flow guiding blocks of the m^{th} row and the first side wall 212 is D2ₘ, and D2ₘ₊₁>D2ₘ>D2. More specifically, the shortest distance between each of the flow guiding blocks 220 of the first row and the first side wall 212 is D2₁, the shortest distance between each of the flow guiding blocks 220 of the second row and the first side wall 212 is D2₂, and D2₂>D2₁>D2.

When the flow channel plate 200 is used as the anode flow channel plate of a fuel cell, fuel flows therein through the inlet 212a. And the solid arrow in FIG. 3 indicates the direction of fuel flow. When fuel flows into the plate body 210 from the inlet 212a, the first flow guiding block 222 splits the fuel. The flow guiding blocks 220 of the second row are disposed on the fuel splitting path, so as to further split fuel. Similarly, the flow guiding blocks 220 of the third row are also disposed on the fuel splitting path, so as to split fuel again. Thus, fuel can evenly flow in the plate body 210 and be evenly distributed on the anode catalyst of the fuel cell, so that the reaction efficiency is increased.

In addition, since the structure of the flow channel plate 200 of the present embodiment is simple and easy to fabricate, therefore the manufacturing cost thereof is relatively low. In addition, since the pressure drop is small when fuel flows in the flow channel plate 200, a pump with smaller power may be used to save energy. Moreover, the flow resistance of the flow channel plate 200 is small, therefore the anode reaction product (for example carbon dioxide) is easier to discharge, and thus an adverse effect on the reaction efficiency can be avoided.

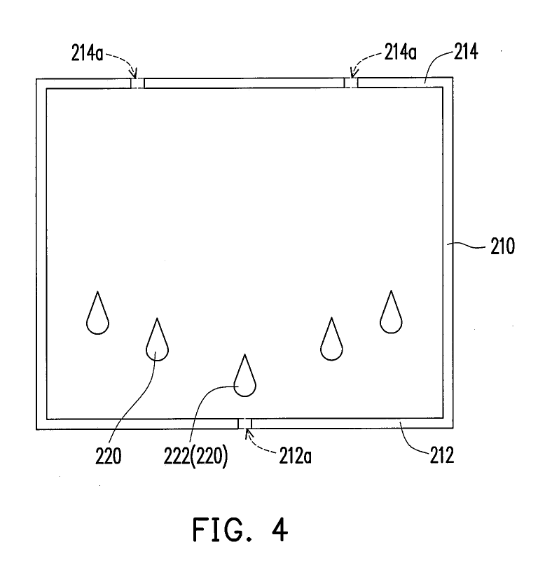

In addition, other than column shape, the shape of the flow guiding block 220 may also be designed in a pear shape as shown in FIG. 4 or other streamline shapes to reduce the stagnant regions of the flow field between the flow guiding blocks 220 and the second side wall 214. Thus the distribution homogeneity of fuel is increased to increase the reaction efficiency. In addition, the number of the outlet 214a may be more than two (as shown in FIG. 4) to increase the distribution homogeneity of fuel, and increase the reaction efficiency. In addition, although in the above embodiment, the number of the flow guiding blocks 220 in each row is only two, however in practical use, the number of the flow guiding blocks 220 in each row may be increased according to the actual need.

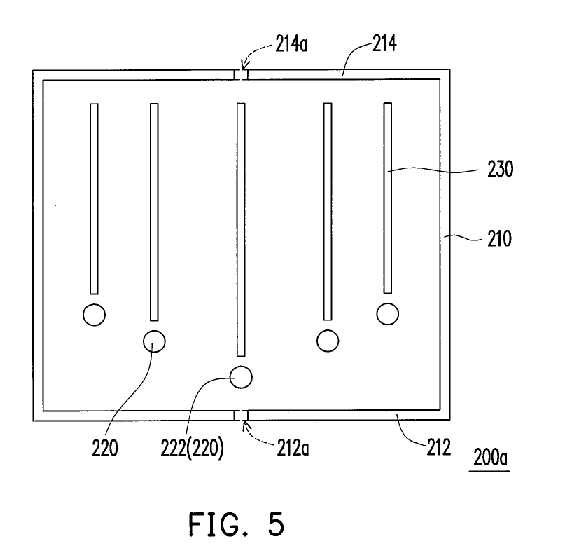

FIG. 5 is a schematic diagram of a flow channel plate according to another embodiment of the present invention. Referring to FIG. 5, compared with the flow channel plate 200 in FIG. 3, the flow channel plate 200a further includes a plurality of strip-shaped flow deflectors 230. The strip-shaped deflectors 230 are disposed between the flow guiding blocks 220 and the second side wall 214, and the longitudinal direction of each strip-shaped flow deflector 230 points toward the first side wall 212 and the second side wall 214. More specifically, the strip-shaped flow deflectors 230, for example, are respectively disposed between each flow guiding block 220 and the second side wall 214. Arrangement of these strip-shaped flow deflectors 230 can make fuel flow more even/uniform between the flow guiding blocks 220 and the second side wall 214, so that the distribution homogeneity of fuel is increased, and the reaction efficiency is therefore increased.

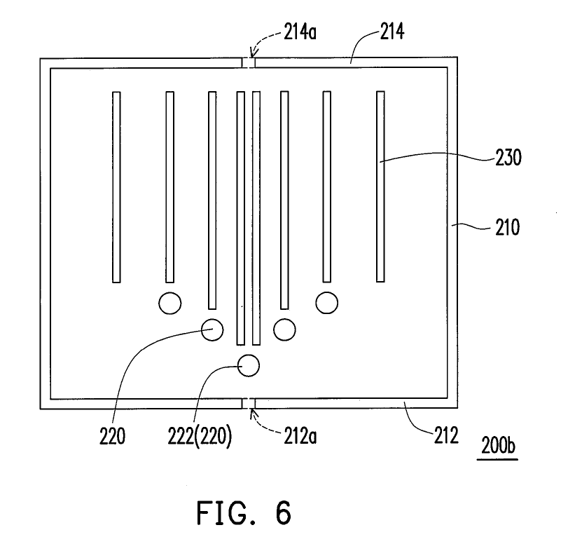

FIG. 6 is a schematic diagram of a flow channel plate according to another embodiment of the present invention. Referring to FIG. 6, the flow channel plate 200b is similar to the flow channel plate 200a in FIG. 5, except for the arrangement of the strip-shaped deflector 230. Specifically, in the flow channel plate 200b, a flow channel is formed between any two adjacent strip-shaped flow deflectors 230, and a width of the flow channel which is closer to the first flow guiding block 222 is smaller than a width of the flow channel which is farther from the first flow guiding block 222.

The flow guiding blocks 220 of the flow channel plate of the present invention may be a plurality of groups, and the number of the inlet 212a and the outlet 214a may be plural. The following descriptions use the flow channel plate with two groups of flow guiding blocks 220, two inlets 212a and two outlets 214a as the example.

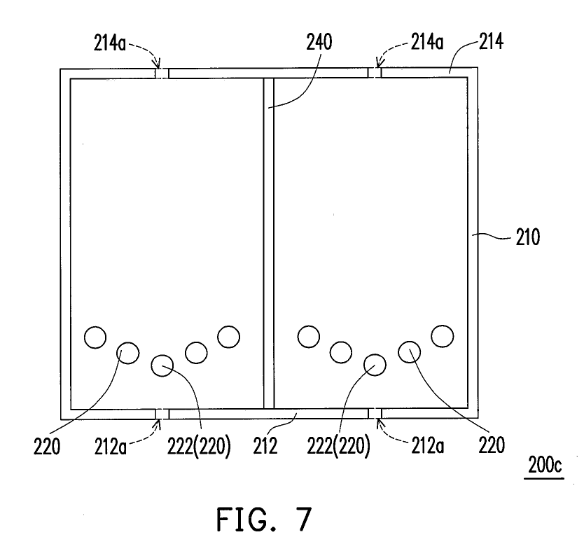

Referring to FIG. 7, the flow channel plate 200c of another embodiment of the present invention includes two groups of flow guiding blocks 220. The first side wall 212 of the plate body 210 has two inlets 212a, and the second side wall 214 has two outlets 214a. Each inlet 212a is opposite to an outlet 214a, and the arrangement of each group of flow guiding blocks 220 is the same as that of the flow guiding blocks 220 of the flow channel plate 200 in FIG. 3. In addition, a separator 240 may be disposed between the two adjacent groups of flow guiding blocks 220, and the separator 240 is connected between the first side wall 212 and the second side wall 214.

Since the flow channel plate 200c has a plurality of groups of flow guiding blocks 220, the fuel flow in the plate body 210 is more uniform, so the reaction efficiency is increased.

To sum up, the flow channel plate of the present invention at least has one of the following advantages:

1. When the flow channel plate of the present invention is used as the anode flow channel plate of a fuel cell, the flow guiding blocks can make the distribution of fuel flow to the flow channel plate uniform, so that fuel uniformly flows to the anode catalyst, and further the reaction efficiency is increased.

2. Since the structure of the flow channel plate of the present invention is simple and easy to fabricate, the manufacturing cost is relatively low.

3. Since the pressure drop of fuel flows is small when the fuel flows in the flow channel plate, a pump with a smaller power may be sufficient and the energy consumption may be reduced.

4. Since the flow resistance of the flow channel plate is small, when the flow channel plate is used as the anode flow channel plate of a fuel cell, the anode reaction product (for example carbon dioxide) may be easily removed, and thus an adverse effect on the reaction efficiency can be avoided.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A flow channel plate, suitable for use in a fuel cell, comprising:
a plate body, having a first side wall and a second side wall opposite to the first side wall, and the first side wall having at least an inlet, and the second side wall having at least an outlet; and
at least a group of flow guiding blocks disposed in the plate body and adjacent to the first side wall, the group of flow guiding blocks comprising a plurality of flow guiding blocks, and one of the flow guiding blocks being a first flow guiding block directly aligned with the inlet; and the rest of the flow guiding blocks arranged into m rows between the first flow guiding block and the second side wall so that the first row of the m rows adjacent to the first flow guiding block; and a number Nₘ of the flow guiding blocks of the m^{th} row is plural, where m is a natural number, and Nₘ₊₁≧Nₘ; wherein a geometrical center of the flow guiding blocks at one end of the first row and a geometrical center of the first flow guiding block are on a straight line, and an included angle is formed between the straight line and the first side wall.

2. The flow channel plate of claim 1, wherein a distance between the two flow guiding blocks at the two ends of the m^{th row is D1}ₘ, and D1ₘ₊₁≧D1ₘ.

3. The flow channel plate of claim 1, wherein the first flow guiding block, the inlet and the outlet are on another straight line.

4. The flow channel plate of claim 1, wherein the inlet is in the center of the first side wall.

5. The flow channel plate of claim 1, wherein the two flow guiding blocks at the two ends of the m^{th} row are respectively at the two sides of the inlet.

6. The flow channel plate of claim 1, wherein the shortest distance between the first flow guiding block and the first side wall is D2, and the shortest distance between each of the flow guiding blocks of the m^{th} row and the first side wall is D2ₘ, and D2ₘ₊₁>D2ₘ>D2.

7. The flow channel plate of claim 1, wherein the dimension of the first flow guiding block is larger than the dimension of the inlet.

8. The flow channel plate of claim 1, wherein the number of the flow guiding blocks is five, and the flow guiding blocks other than the first flow guiding block are arranged in two rows.

9. The flow channel plate of claim 8, further comprising a plurality of strip-shaped flow deflectors disposed between the flow guiding blocks and the second side wall, and the longitudinal direction of each strip-shaped flow deflector pointing toward the first side wall and the second side wall.

10. The flow channel plate of claim 9, wherein the strip-shaped flow deflectors are respectively disposed between each flow guiding block and the second side wall.

11. The flow channel plate of claim 9, wherein a flow channel is formed between any two adjacent strip-shaped flow deflectors, and a width of the flow channel which is closer to the first flow guiding block is smaller than a width of the flow channel which is farther from the first flow guiding block.

12. The flow channel plate of claim 1, comprising a plurality of groups of flow guiding blocks, and the first side wall comprising a plurality of inlets, and the second side wall comprising a plurality of outlets.

13. The flow channel plate of claim 12, further comprising at least a separator, connected to the first side wall and the second side wall, and disposed between two adjacent groups of flow guiding blocks.

14. The flow channel plate of claim 1, wherein a shape of the flow guiding block comprises column, pear shape or a streamline shape.
